(19) United States
(12) Patent Application Publication
(10) Pub. No.: US 2002/0051861 A1
(43) Pub. Date: May 2, 2002

(54) Tamper evident containers and method for making the same

(76) Inventor: Antony Brian Jennings, Alderholt (GB)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/940,234

(22) Filed: Aug. 27, 2001

Related U.S. Application Data
(63) Continuation of application No. PCT/GB00/00701, filed on Feb. 28, 2000.

(30) Foreign Application Priority Data
Feb. 26, 1999 (GB) 9904551.0
May 12, 1999 (GB) 9911076.9

(51) Int. Cl. B44C 1/26

(52) U.S. Cl. 428/67; 156/276; 428/199

(57) ABSTRACT

A method of forming a cold detect on a substrate comprising the steps of applying an adhesive to a surface of a substrate and applying an intimate mixture of an indicator and a finely-divided moisture absorbent carrier to the adhesive-coated substrate to form a cold detect. The cold detect may be used as a closure adhesive to seal an adhesively-closable container, such as a security bag for bank notes or forensic evidence.

### RELATED APPLICATIONS

This application is a continuation of International Patent Application Ser. No. PCT/GB00/00701, filed Feb. 28, 2000, which claims priority to GB application Ser. No. 9904551.0, filed Feb. 26, 1999 and GB application Ser. No. 9911076.9, filed May 12, 1999

### DESCRIPTION

The present invention relates to tamper evident containers and a method for making the same. In particular, the present invention relates to tamper evident containers, such as security bags or envelopes for containing bank notes or forensic evidence, which have a cold detect that can be hidden from view when the container is sealed.

Certain bank note envelopes are closed by means of an adhesive of a type which can be released at relatively high or low temperatures, that is usually close to the boiling point or below the freezing point of water. Such envelopes generally use hot melt adhesives that lose adhesion when heated or frozen but return to adhesion on reaching normal temperature, thereby allowing a thief sufficient time to open and close the bag without leaving evidence of tampering. [Any attempt to open the envelope at ambient temperature, when the adhesive has not lost its tackiness, would simply tear the bag, thereby providing visible evidence of tampering.] Security requirements often dictate that such envelopes should be capable of indicating when the container has been opened without authority. The use of thermochromic inks or dyes as heat detects that change colour irreversibly on heating above a critical temperature, to provide evidence of tampering by heating the envelope, for example, with a hair dryer, is well-known. Since the colour change occurs as a direct result of heating, the thermochromic inks or dyes can be covered with a protective layer or incorporated into the closure adhesive, for example, with a masking pigment, thereby rendering them substantially inconspicuous when the envelope is closed.

British Patent No. 2,270,857 discloses a bank note envelope having a cold detect in the form of a woven polypropylene band, along whose length are incorporated small spots of a bright dye, such as fluorescein sodium, in powder form, so as not to appreciably colour the band. The polypropylene band is located close to the envelope's closure flap, but in such a position so as not to be covered by the closure flap when closed normally. When the closed envelope is exposed to a sharp decrease in temperature such as to cause the closure adhesive to lose tackiness, for example, by immersion in liquid nitrogen or spraying with an aerosol cold spray of the kind used by plumbers, etc., condensation forms on the polypropylene band, thereby causing the dye spots to dissolve and the resulting colour to spread throughout the band. Alternatively, the dye may also be applied directly onto a capillary/writable surface formed on the envelope, in such quantity as to negligibly, incompletely or only lightly shade the surface of the envelope when dry, but sufficient to spell out a warning message in the presence of moisture.

However, envelopes such as those described in British Patent No. 2,270,857 suffer from a number of disadvantages. Since the colour change occurs as an indirect result of cooling, the cold detect cannot be covered by any protective layer that would prevent the dye from coming into contact with moisture. This means that, if the outside of the envelope should become damp or moist for any reason other than tampering, the cold detect may give a false reading. Moreover, as the cold detect is not covered by the envelope's closure flap, it remains accessible and is, therefore, potentially vulnerable to tampering. For example, a professional tamperer might attempt to cover the cold detect before opening the envelope, or might attempt to freeze the envelope only in the immediate vicinity of the closure flap.

One possible solution would be to locate the cold detect in such a position so as to be covered by the closure flap when closed normally. It has been found, however, that cold detects of the kind described in British Patent No. 2,270,857 are relatively insensitive and produce little or no reaction when used in this way. It is an object of the present invention to overcome some of the aforementioned disadvantages.

Accordingly, in first aspect of the invention, there is provided a method of forming a cold detect on a substrate comprising the steps of applying an adhesive to a surface of a substrate and applying to the adhesive-coated substrate an intimate mixture of an indicator and a finely-divided moisture absorbent carrier, to form a cold detect.

In a second aspect of the invention, there is provided a method of forming a cold detect on a substrate comprising the steps of applying an adhesive to a surface of a substrate and applying to the adhesive-coated substrate an intimate mixture of an indicator and a carrier capable of absorbing moisture by capillary attraction, to form a cold detect.

In the context of the present invention, the term “cold detect” is understood to refer to means for detecting whether the substrate has been subjected to a significant decrease in temperature, such as that required to make the closure adhesive on an adhesively-closeable container lose tackiness. Similarly, “heat detect” is understood to refer to means for detecting whether the substrate has been subjected to a significant increase in temperature, such as that required to make the closure adhesive melt and so lose tackiness. The cold detect preferably changes colour irreversibly upon exposure to moisture resulting from condensation formed when the substrate is cooled to a temperature below the dew point of the surrounding air. Thus, if the substrate is cooled to a temperature below the dew point of the surrounding air, condensation will form on the substrate and the resultant moisture will react with the indicator in the cold detect to produce an irreversible colour change. In this embodiment, the cold detect may also change colour irreversibly on exposure to other forms of moisture, such as spittle, for example, or to other solvents, preferably organic solvents. This has the advantage that a single cold detect may be used not only to provide evidence of “cold” tampering by freezing but also by prewetting or moistening of the adhesive at low or ambient temperature to make it lose tackiness. In an embodiment, the adhesive is applied directly to the surface of the substrate, for example, by spraying or coating onto the substrate. Alternatively, the adhesive may be applied to the surface of the substrate via a support, such as a double-sided tape. In the latter case, the tape is coated with an adhesive on both sides, one side being used for sticking the tape to the substrate and the other side being free for application of the intimate mixture. The adhesive used in the invention will generally be a hot melt adhesive, although other forms of adhesive having the necessary binding and coating properties may also be utilised.

In the context of the present invention, the term “intimate mixture” is understood to refer to a mixture in which the indicator is thoroughly dispersed in the carrier, such that the mixture is substantially devoid of large clumps of indicator. The step of forming an intimate mixture of the indicator and the moisture absorbent substance in the inventive method results in a cold detect that has greatly enhanced sensitivity. It is believed that this is due, at least in part, to greater mobility of the indicator, possibly as a result of reduced cohesive forces between indicator molecules or increased electrostatic interaction between indicator molecules and the carrier, although the exact mechanism is not fully understood. In a preferred embodiment, the intimate mixture of the indicator and the moisture absorbent carrier is applied to the adhesive-coated substrate before the adhesive has dried or set, either at all or completely. This has the advantage that the mixture of indicator and carrier becomes incorporated into the uppermost surface of the adhesive as it dries or sets, thereby fixing the mixture in place. In an equally preferred embodiment, however, the intimate mixture is applied to the adhesive-coated substrate after the adhesive has dried or set. In either embodiment, the intimate mixture is preferably applied to the surface of the substrate in the form of a dry powder. For example, the mixture may be loaded into a plastic bottle with a nozzle and lightly puffed onto the surface of the adhesive. This has the advantage that the mixture may be applied in small amounts, without greatly affecting the adhesion properties of the adhesive, as well as making this method of application very economical. Preferably, the intimate mixture is applied very sparsely to the surface of the adhesive, such that substantial areas or regions of the adhesive remain uncoated to provide an aggressively tacky surface. Alternatively, the intimate mixture could be applied to a discrete region or regions of the surface of the adhesive, for example, in the form of a thin band or strip(s). In a preferred embodiment, the intimate mixture is applied to a track or channel recessed within the surface of the adhesively-coated substrate, such that the regions of the adhesively coated substrate immediately adjacent to the track or channel remain uncoated to provide an aggressively tacky surface. The track or channel may be of any suitable width to provide a clear indication of tampering, but is preferably in the order of 1-10 mm, more preferably 2-6 mm, and most preferably about 5 mm. Preferably, the track or channel is provided with a powder-receptive surface, to retain the intimate mixture. In an especially preferred embodiment, the powder-receptive surface is formed of a material that does not lose its affinity for the intimate mixture when the adhesively-coated substrate is subjected to a significant decrease in temperature, such as that required to make the adhesive lose its tackiness. This has the advantage that the intimate mixture remains firmly bound to the substrate, even if the adhesive should lose adhesion and become transferred from the adhesively-coated substrate to another surface. Suitable powder-receptive surfaces include those formed of dried but tacky latex, total solids glue, double-sided tape and porous/absorbent materials such as paper, but many other powder-receptive surfaces are also possible. However, other methods of applying the intimate mixture to the surface of the substrate, in an amount sufficient to act as a cold detect but insufficient to affect substantially the adhesive properties of the adhesive-coated substrate, will be readily apparent to those skilled in the art. The intimate mixture used in the invention has the surprising advantage of being highly sensitive and, therefore, is not required to be present in significant amounts. Preferably, a release paper is applied to the surface of the cold detect, after the mixture of the indicator and carrier has been applied, to prevent the adhesive from sticking to random objects and making the substrate easier to handle.

In the context of the present invention, the term “indicator” is understood to refer to any compound that is capable of providing an indication that the substrate has been subjected to a significant decrease in temperature. Preferably, the indicator is dye. In an embodiment, the indicator is a concentrated dye, which produces a strong, vivid colour and is sensitive to small amounts of water, such as, for example, a batik dye. However, other dyes that provide a clear and irreversible colour change on contact with moisture are also equally suitable. In one aspect of the invention, the moisture absorbent carrier is finely-divided, such that it provides a relatively high surface area to any moisture that may be present. In another aspect of the invention, the carrier is capable of absorbing moisture by capillary attraction, such that it provides a “wicking” effect to draw up any moisture that may be present. In either aspect, the moisture absorbent carrier effectively captures trace amounts of ambient moisture and helps to ensure that this is rapidly brought into contact with the indicator dispersed therein. When the cold detect according to the invention is applied, for example, to a security bag and the latter is sealed in the normal way, if a cold spray is applied to the closure portion of the bag in an attempt to make the closure adhesive loose tackiness, the moisture absorbent carrier will generally be capable of absorbing sufficient moisture to make the indicator change colour even before the bag is opened, thus providing evidence of any attempt at tampering. The moisture absorbent carrier is preferably a fine powder, which provides a large surface area for the dissolved dye to spread over, such as an aluminosilicate, especially a talc. The ratio of dye to moisture absorbent carrier in the intimate mixture, in parts by weight, may be about 1: 1 to 100. Generally, though, the dye will be present in a smaller amount by weight than the carrier, and the ratio is, preferably about 1: 5 to 50, more preferably about 1: 10 to 30 and, most preferably, about 1 part by weight dye to 20 parts by weight carrier. In an embodiment, the substrate forms or is adapted to form part of an adhesively-closeable container, such as a security bag or an envelope or the like, although it is envisaged that the invention may equally be applied to various other forms of container. In a preferred embodiment, the cold detect on the substrate forms or is adapted to form the adhesive closure of the bag or envelope, such that the cold detect not only serves to seal the bag or envelope but also to provide evidence of tampering if the bag or envelope is unsealed without authorisation. Preferably, the substrate forms part of a closure flap of the bag or envelope and the cold detect forms the closure adhesive on the flap. This has a number of advantages, most notably, that the cold detect becomes hidden when the bag or envelope is closed. Thus, a would-be tamperer is unaware of the presence of the cold detect until the bag has been opened, and thus cannot take any steps to avoid activating it. Also, in trying to open the bag or envelope after cooling it, the tamperer's fingers are likely to come into contact with the moistened indicator, thereby marking the tamperer for subsequent identification, especially if a wash-resistant dye is used. Another advantage is that the cold detect and adhesive closure may be formed on or applied to the bag or envelope in a single manufacturing step, for example, by applying a double-sided tape with the cold detect ready applied on one side. In the latter embodiment, the double-sided tape may be attached to the bag or envelope by gluing or by welding, although other means of attachment are also possible. In a preferred embodiment, the cold detect is applied to a tape that can be applied to a suitable bag or envelope by welding at least one edge of the tape to the bag or envelope, preferably in the vicinity of the bag's opening.

In another embodiment, the intimate mixture further includes at least one substance capable of producing moisture on heating, to form a combined cold and heat detect. Preferably, the heat detect changes colour irreversibly when the substrate is heated to a temperature at or above that at which the substance produces moisture, as a result of the indicator reacting with the moisture formed in situ within the carrier. Substances suitable for this purpose include metal hydroxides and hydrated metal salts, although any other hydrates that give off water on heating may also be used. In a yet further embodiment, the inventive method includes the step of providing the substrate or the subject container of which the substrate forms a part with means adapted to register whether or not the cold detect has been activated and the indicator subsequently removed, for example, by washing the substrate with bleach. Preferably, the means comprise a message that is normally hidden but becomes displayed when the indicator is removed. For example, the message might be written in the same dye as the main indicator but against a contrasting background, so that when both are removed together the message is still visible in negative. Alternatively, the means may comprise a reagent that reacts with an oxidant to produce a detectable chemical change, for example, on exposure to a bleach.

In a third aspect of the invention, there is provide a substrate having a cold detect formed by applying an adhesive to a surface of a substrate and applying to the adhesive-coated substrate an intimate mixture of an indicator and a finely-divided moisture absorbent carrier.

In a fourth aspect of the invention, there is provide a substrate having a cold detect formed by applying an adhesive to a surface of a substrate and applying to the adhesive-coated substrate an intimate mixture of an indicator and a carrier capable of absorbing moisture by capillary attraction.

The invention in its third or fourth aspects may have any of the preferred features described above in relation to the invention in its first or second aspects.

In a fifth aspect of the invention, there is provided a security bag or envelope having a cold detect that also serves as the closure adhesive to seal the bag or envelope.

In order that the invention may be better understood, two specific embodiments thereof will now be described, by way of illustration only, with reference to the accompanying drawing, in which:

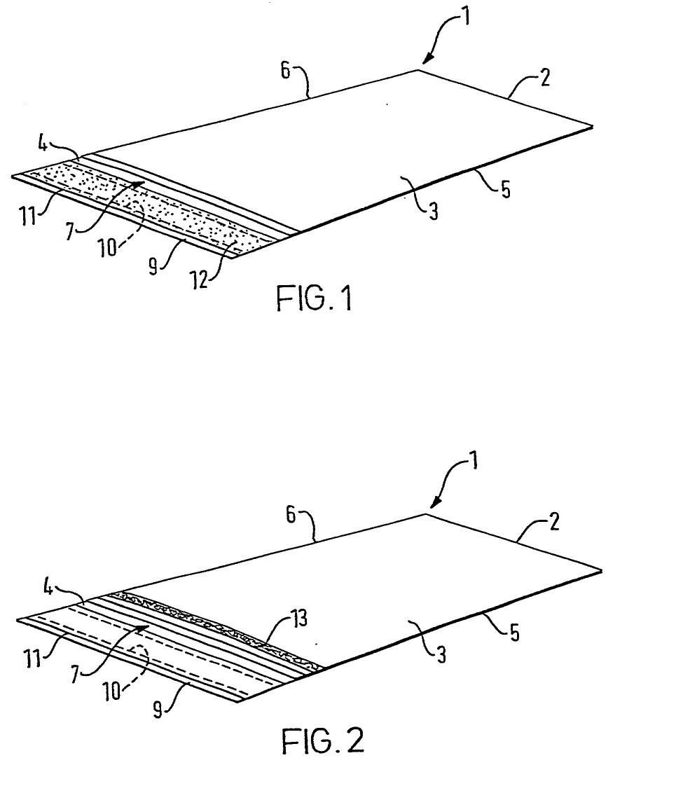

FIG. 1 is a perspective view of an envelope according to a first embodiment of the invention; and

FIG. 2 is a perspective view of an envelope according to a second embodiment of the invention.

In FIG. 1, an envelope 1 suitable for containing bank notes or forensic evidence (not shown), which comprises a single sheet of polyethylene, folded at one end 2 to define upper and lower skins 3,4 welded together at their edges 5,6. A mouth is provided at the other end 7 by the free edge 8 of the upper skin 3. The lower skin 4 has a continuation beyond the mouth, which forms a closure flap 9. The closure flap 9 has hot melt adhesive 10 applied to it, with a release film 11 generally applied over the adhesive 10, to protect the envelope against inadvertent closure. In these respects, the envelope is conventional. In ordinary use, Envelope 1 is closed by removal of the release film 11 and folding of the flap onto upper skin 3, where it sticks. Normally, the envelope cannot now be opened without tearing of its polyethylene skins. However, if the temperature of the adhesive is raised as by steaming, or if it is cooled to less than 0° C., the adhesive loses its tackiness and the flap can be opened without plastic deformation of the polyethylene.

In accordance with the invention, however, the surface of the hot melt adhesive 10 is sparsely coated with an intimate mixture of one part by weight Dylon M5B red dye and 20 parts by weight Boots Baby Powder, using a puffer bottle (not shown), prior to application of the release film 11. The sparsity of coating is such that significant regions of the hot melt adhesive remain uncoated to provide aggressive surfaces. The release film 11 is then removed to seal the envelope in the usual way. If a tamperer opens the envelope by cooling it to a temperature at which the adhesive loses its adhesion, for example, by immersing the envelope or closure portion thereof in liquid nitrogen, condensation forms on the cold detect 12 and the moisture causes the indicator to spread throughout the talc and turn the latter from off-white to bright red.

FIG. 2 shown as alternative embodiment of the invention, in which an intimate mixture of red batik dye and talc is applied to one side of a piece of double-sided adhesive tape 13, the other side being used to secure the tape to the upper skin 3, just below the mouth of the envelope 1, so that the tape 13 is covered by the closure flap 9 when the envelope is sealed. The cold detect on tape 13 may also be partially or completely covered by the hot melt adhesive 10.

What is claimed is:

1. A method of forming a cold detect on a substrate comprising the steps of applying an adhesive to a surface of a substrate and applying to the adhesive-coated substrate an intimate mixture of an indicator and a finely-divided moisture absorbent carrier, to form a cold detect.

2. A method of forming a cold detect on a substrate comprising the steps of applying an adhesive to a surface of a substrate and applying to the adhesive-coated substrate an intimate mixture of an indicator and a carrier capable of absorbing moisture by capillary attraction, to form a cold detect.

3. A method as in claim 1, wherein the cold detect changes colour irreversibly upon exposure to moisture resulting from condensation formed when the substrate is cooled to a temperature below the dew point of the surrounding air.

4. A method as in claim 1, wherein the cold detect is adapted to change colour irreversibly upon exposure to a solvent capable of dissolving the adhesive.

5. A method as in claim 4, wherein the solvent is an organic solvent.

6. A method as in claim 4, wherein the solvent is an aqueous solvent, preferably spittle.

7. A method as in claim 1, wherein the adhesive is applied directly to the surface of the substrate.

8. A method as in claim 1, wherein the adhesive is applied to the surface of the substrate via a support.

9. A method as in claim 8, wherein the support is a double-sided tape.

10. A method as in claim 1, wherein the adhesive is a hot melt adhesive.

11. A method as in claim 1, wherein the intimate mixture is applied to the adhesive-coated substrate before the adhesive has dried or set.

12. A method as in claim 3, wherein the intimate mixture is applied to the adhesive-coated substrate after the adhesive has dried or set.

13. A method as in claim 1, wherein the intimate mixture is applied to the surface of the substrate in the form of a dry powder.

14. A method as in claim 1, wherein the intimate mixture is applied to the surface of the substrate in an amount sufficient to act as a cold detect but insufficient to affect substantially the adhesive properties of the adhesive-coated substrate.

15. A method as in claim 14, wherein the intimate mixture is applied to a discrete region of the surface of the substrate, preferably as a band or strip.

16. A method as in claim 15, wherein the intimate mixture is applied to a track or channel recessed within the surface of the substrate.

17. A method as in claim 16, wherein the average width of the track or channel is in the order of 1-10 mm, preferably 2-8 mm, and most preferably about 5 mm.

18. A method as in claim 16, wherein the track or channel is provided with a surface that is adapted to receive the intimate mixture, preferably with a powder-receptive surface.

19. A method as in claim 18, wherein the surface adapted to receive the track or channel is formed of a material which does not lose its affinity for the intimate mixture when the substrate is cooled to a temperature below the dew point of the surrounding air.

20. A method as in claim 14, wherein the intimate mixture is applied randomly to the surface of the substrate, such that regions of the surface are substantially uncoated.

21. A method as in claim 1, further comprising applying a release paper to the surface of the cold detect.

22. A method as in claim 1, wherein the indicator is a dye.

23. A method as in claim 22, wherein the indicator is a concentrated dye that produces a strong or vivid colour in the presence of trace amounts of solvent.

24. A method as in claim 23, wherein the indicator is a batik dye.

25. A method as claim 1, wherein the moisture absorbent carrier is a fine powder.

26. A method as in claim 25, wherein the moisture absorbent carrier is an aluminosilicate, preferably a talc.

27. A method as claim 22, wherein the ratio of dye to moisture absorbent carrier in the intimate mixture, in parts by weight, is about 1: 1 to 100, preferably about 1: 5 to 50, more preferably about 1: 10 to 30 and, most preferably, about 1 part by weight dye to 20 parts by weight carrier.

28. A method as in claim 1, wherein the substrate forms or is adapted to form part of an adhesively-closeable container.

29. A method as in claim 28, wherein the adhesively-closeable container is a security bag, a security envelope, or the like.

30. A method as in claim 29, wherein the cold detect on the substrate forms or is adapted to form the adhesive closure of the bag or envelope.

31. A method as in claim 30, wherein the substrate forms part of a closure flap of the bag or envelope and the cold detect forms the closure adhesive on the flap.

32. A method as in claim 29, wherein the substrate is attached to the bag or envelope by gluing or welding.

33. A method as in claim 28, wherein the cold detect is hidden from view when the container is closed.

34. A method as in claim 1, where the intimate mixture further includes at least one substance capable of producing moisture on heating, to form a combined cold and heat detect.

35. A method as in claim 34, wherein the heat detect changes colour irreversibly when the substrate is heated to a temperature at or above that at which the substance produces moisture.

36. A method as in claim 34, wherein the substance is a metal hydroxide or a hydrated metal salt.

37. A substrate having a cold detect formed by applying an adhesive to a surface of a substrate and applying to the adhesive-coated substrate an intimate mixture of an indicator and a finely-divided moisture absorbent carrier.

38. A substrate having a cold detect formed by applying an adhesive to a surface of a substrate and applying to the adhesive-coated substrate an intimate mixture of an indicator and a carrier capable of absorbing moisture by capillary attraction.

39. A substrate as in claim 37, wherein the cold detect changes colour irreversibly upon exposure to moisture resulting from condensation formed when the substrate is cooled to a temperature below the dew point of the surrounding air.

40. A substrate as in claim 37, wherein the adhesive is a hot melt adhesive.

41. A substrate as in claim 37, wherein the adhesive properties of the adhesive-coated substrate are not substantially affected by the presence of the indicator and carrier mixture.

42. A substrate as in claim 41, wherein the intimate mixture is applied to a discrete region of the surface of the adhesively-coated substrate, preferably as a band or strip.

43. A substrate as in claim 42, wherein the intimate mixture is applied to a track or channel recessed within the surface of the substrate.

44. A substrate as in claim 43, wherein the average width of the track or channel is in the order of 1-10 mm, preferably 2-8 mm, and most preferably about 5 mm.

45. A substrate as in claim 43, wherein the track or channel is provided with a surface that is adapted to receive the intimate mixture, preferably with a powder-receptive surface.

46. A substrate as in claim 45, wherein the surface adapted to receive the track or channel is formed of a material which does not lose its affinity for the intimate mixture when the substrate is cooled to a temperature below the dew point of the surrounding air.

47. A substrate as in claim 41, wherein the intimate mixture is applied randomly to the surface of the substrate, such that regions of the surface are substantially uncoated.

48. A substrate as in claim 37, further comprising a release paper attached to the adhesive surface of the substrate.

49. A substrate as in claim 37, wherein the intimate mixture contains about 1 part by weight batik dye to 20 parts by weight talc.

50. A substrate as in claim 37, forming or adapted to form part of an adhesively-closeable container.

51. A substrate as in claim 50, wherein the adhesively-closeable container is a security bag, envelope, or the like.

52. A substrate as in claim 51, wherein the substrate is attached to the bag or envelope by gluing or welding, preferably by welding.

53. A substrate as in claim 37, for use as a cold detect on an adhesively-closeable container.

54. A substrate as-in claim 53, in the form of a tape or label suitable for attachment to an adhsively-closeable container.

55. A substrate as in claim 54, in the form of a tape having at least one edge suitable for welding to the container.

56. A substrate as in claim 37, wherein the intimate mixture further includes a substance capable of producing moisture on heating, to form a combined cold and heat detect, the substance preferably a metal hydroxide or a hydrated metal salt.

57. A substrate as in claim 37, further comprising means adapted to register whether or not the cold detect has been activated and the indicator subsequently removed.

58. A substrate as in claim 57, wherein the means comprise a message that is normally hidden but becomes displayed when the indicator is removed.

59. A substrate as in claim 58, wherein the means comprise a reagent that reacts with an oxidant to produce a detectable chemical change, preferably a reagent that reacts with a bleach.

60. A security bag or envelope having a cold detect that also serves as the closure adhesive to seal the bag or envelope.
